(19) United States
(12) Patent Application Publication
(10) Pub. No.: US 2019/0179847 A1
(43) Pub. Date: Jun. 13, 2019

(54) SLIDE SHOW CONTROL METHOD AND APPARATUS

(71) Applicant: GUANGZHOU SHIRUI ELECTRONICS CO., LTD., Guangzhou, OT (CN)

(72) Inventor: Dongjie Wang, Guangzhou (CN)

(73) Assignee: GUANGZHOU SHIRUI ELECTRONICS CO., LTD., Guangzhou, OT (CN)

(21) Appl. No.: 16/209,314

(22) PCT Filed: Dec. 29, 2016
(86) PCT No.: PCT/CN2016/113223

§ 371 Date: Dec. 4, 2018

(30) Foreign Application Priority Data
Jun. 8, 2016 (CN) 201610407867.8

(51) Int. Cl. G06F 16/438; G06F 17/24; G06F 3/0483

(52) U.S. Cl. CPC G06F 16/4393; G06F 3/0483; G06F 17/24

(57) ABSTRACT

Provided are a slide show control method and an apparatus. The method includes: displaying (S102) a control interface in a slide show interface, receiving (S104) a switch instruction acting on a thumbnail, and in response to the switch instruction, obtaining (S106) the slide page corresponding to the thumbnail on which the switch instruction acts and switching the slide page currently displayed in the slide show interface to the slide page corresponding to the thumbnail on which the switch instruction acts. With the control interface displayed in the slide show interface, after the user inputs the switch instruction on the thumbnail in the control interface, the slide page currently displayed in the slide show interface can be automatically switched to the slide page corresponding to the thumbnail on which the switch instruction acts. And even when a touch device is used to present the slides, the page switch can be done in the show state, which simplifies the user's operation.

### TECHNICAL FIELD

The present invention relates to the field of multimedia display technologies and, in particular to a slide show control method and apparatus.

### BACKGROUND

In the daily work, study and technical exchanges, a user usually uses slides (such as PPT) as the form to explain and present a file in a vivid, convenient and organized way. Slide files are widely used on occasions of academic reporting, thesis defense and business meetings etc. Using a slide file can help the speaker clearly and vividly express his thoughts or ideas.

Because the interaction with PPT is designed based on the traditional keyboard and mouse, using a touch device to present a PPT file is very inconvenient. When PPT is in the show state, to apply show controls on the PPT, one can only long press the screen to popup the right-click menu and then make selections in the menu. Such operation is very inconvenient.

### SUMMARY

Based on that, to solve the above-identified technical problems, it is necessary to provide a slide show control method and apparatus that can simplify the user's operation when a touch device is used to present slides.

A slide show control method includes the following steps:

displaying a control interface in a slide show interface, where a thumbnail corresponding to a slide page is displayed in the control interface;

receiving a switch instruction acting on the thumbnail;

in response to the switch instruction, obtaining the slide page corresponding to the thumbnail on which the switch instruction acts, and switching a slide page currently displayed in the slide show interface to the slide page corresponding to the thumbnail on which the switch instruction acts.

A slide show control apparatus includes:

an interface displaying module to display a control interface in a slide show interface, where a thumbnail corresponding to a slide page is displayed in the control interface;

an instruction obtaining module to receive a switch instruction acting on the thumbnail;

a page switching module to, in response to the switch instruction, obtain the slide page corresponding to the thumbnail on which the switch instruction acts, and switch a slide page currently displayed in the slide show interface to the slide page corresponding to the thumbnail on which the switch instruction acts.

With the above slide show control method and apparatus, the control interface is displayed in the slide show interface, and the switch instruction acting on the thumbnail is received. In response to the switch instruction, the slide page corresponding to the thumbnail on which the switch instruction acts is obtained, and the slide page currently displayed in the slide show interface is switched to the slide page corresponding to the thumbnail on which the switch instruction acts. With the control interface displayed in the slide show interface, after the user inputs the switch instruction on the thumbnail in the control interface, the slide page currently displayed in the slide show interface can be automatically switched to the slide page corresponding to the thumbnail on which the switch instruction acts. And even when a touch device is used to present the slides, the page switch can be done in the show state, which simplifies the user's operation.

### BRIEF DESCRIPTION OF DRAWINGS

FIG. 1 is a flow diagram of a slide show control method in an embodiment;

FIG. 2 is a flow diagram of a slide show control method in another embodiment;

FIG. 3 is a schematic diagram of a control interface in an embodiment;

FIG. 4 is a detailed schematic diagram of an interface displayed in an embodiment;

FIG. 5 is a schematic diagram of a writing interface in an embodiment;

FIG. 6 is a structural diagram of a slide show control apparatus in an embodiment;

FIG. 7 is a structural diagram of a slide show control apparatus in another embodiment.

### DESCRIPTION OF EMBODIMENTS

A slide show control method in an embodiment is illustrated by being applied to an intelligent terminal having a slide show function. As shown in FIG. 1, the above method includes the following steps:

Step S102: displaying a control interface in a slide show interface.

A thumbnail corresponding to a slide page is displayed in the control interface. The slide show interface refers to an interface for showing slides, which can be displayed in the screen of the intelligent terminal in a full-screen manner or displayed in a window. A slide is a playable file composed of text and pictures with certain special and dynamic display effects added therein. Specifically, the file format of a slide show can include, for example, PowerPoint, Keynote, Pages and Numbers, etc. The thumbnail is linked to the corresponding slide page, and serves as a preview and a catalog of an image file. The specific number of thumbnails corresponds to the number of pages of the slides. The thumbnail is obtained by taking a screenshot of the slide page, either before or after a slide show event is triggered. In this embodiment, the thumbnails are obtained by taking screenshots of the slide pages after a slide show event is triggered, and are displayed in the control interface, corresponding to the respective slide pages. The thumbnails may be generated during the slide show, avoiding procedural wastes. In addition, when the number of thumbnails is more than one, the thumbnails can be combined according to the presentation order of the slide pages and then displayed in the control interface in the form of a thumbnail list.

The control interface can be displayed in the slide show interface, either when the slide is detected as being in the show state, or when the slide is detected as being in the show state and a start instruction is received. Specifically, the start instruction can be input either by a touch operation in the slide show interface, such as a click or slide operation with a finger, or by clicking a mouse. Taking the touch operation as an example, when the slide is in the show state, if a user's touch operation in the slide show interface is detected, then the control interface is displayed in the slide show interface to enable the user to control over the slide show.

Specifically, by monitoring the slide state, when the slide is detected as being in the show state, a slide show event is triggered and the control interface is displayed in the slide show interface. The control interface can be displayed either in the full-screen manner or in a partial area of the slide show interface. The specific way of monitoring the slide state is not unique, which can either be directly monitoring the parameter change of a slide control program to confirm the slide state, or be monitoring the state of the background program in the intelligent terminal to confirm the slide state, or be monitoring the slide state through a third-party component.

Upon the confirmation of the slide show event being triggered, the thumbnails can be displayed in the control interface at the same time when the control interface is displayed in the slide show interface, or, with the control interface being displayed, the thumbnails are displayed after a triggering instruction is received. For example, the thumbnails are displayed after the user's click operation on the control interface is received. Specifically, a page number display box is displayed in the control interface, and step S102 includes: displaying the control interface in the slide show interface, and displaying the thumbnails in the control interface after receiving a click instruction acting on the page number display box in the control interface. Specifically, the click instruction can either be an instruction produced by a touch operation, such as an instruction produced by the user clicking the page number display box with a finger or a stylus, or be an instruction produced by clicking the page number display box with the mouse arrow pointer. The page number display box displaying the page number of the slide can be set in the control interface at first, specifically the page number display box can be displayed on one or more sides of the control interface. In this embodiment, the page number display box is displayed on two opposite sides of the control interface, and the thumbnails are then displayed after the click instruction acting on the page number display box is received. When showing the slides, the user can choose according to actual situation whether to display the thumbnails for assisting the page switch operation or not, improving the convenience of the slide show operation.

Step S104: receiving a switch instruction acting on the thumbnail.

The switch instruction is used to select a thumbnail so as to switch to the corresponding slide for display. The way of inputting the switch instruction is not unique. Specifically, the switch instruction can either be produced by a touch operation, such as clicking the thumbnail with a finger or a stylus to input the switch instruction, or be input by clicking the mouse.

S106: in response to the switch instruction, obtaining the slide page corresponding to the thumbnail on which the switch instruction acts, and switching the slide page currently displayed in the slide show interface to the slide page corresponding to the thumbnail on which the switch instruction acts.

In this embodiment, after the switch instruction is received, the thumbnail on which the switch instruction acts are obtained, and the slide page currently displayed in the slide show interface is switched to the slide corresponding to the thumbnail on which the switch instruction acts. With a thumbnail display function added in the show state, the user can view the slide content via the thumbnail, and a page jump operation can be swiftly completed by clicking the thumbnail corresponding to the page to be jumped to.

In the above slide show control method, the control interface is displayed in the slide show interface. After the user inputs the switch instruction on the thumbnail in the control interface, the slide page currently displayed in the slide show interface can be automatically switched to the slide page corresponding to the thumbnail on which the switch instruction acts. And even when a touch device is used to present the slides, the page switch can also be done in the show state, simplifying the user's operation.

In one of embodiments, the control interface is further provided with a page-turning button. The above method can also include the following steps:

receiving a page-turning instruction acting on the page-turning button in the control interface, and conducting a page-turning operation on the slide page according to the page-turning instruction.

The page-turning button(s) can be displayed on one or more sides of the control interface, and the page-turning instruction can also be generated by a touch operation or by clicking the mouse. With a page-turning function added on the basis of the thumbnail display function, the user can make choices according to actual demand, for example, clicking the thumbnail when the page jump and switch is needed, and clicking the page-turning button when the page turning is needed, thus improving the convenience of the slide show operation.

Specifically, in this embodiment, the page-turning buttons are displayed on two opposite sides of the control interface for ease of the user's page-turning operation. Specifically, the page-turning buttons include a page-up button and a page-down button, which are set on the two sides of the page number display box, respectively. The user can turn the slide page upward and downward by clicking the page-up button and the page-down button, further improving the convenience of the slide show operation.

Further, the above method includes the following steps:

when a slide page switch is detected, obtaining the page number of the currently displayed slide page and displaying this page number in the page number display box in the control interface.

Similarly, the slide state can be either confirmed by directly monitoring the parameter change of the slide control program, or monitored through a third-party component. When the user switches the page by clicking the thumbnail, or turns over the page through the page turning function, the presented slide page change being detected triggers a slide switch event, and the page number of the currently displayed slide page is obtained and displayed in the page number display box to have the page number updated.

A page number update function is provided in this embodiment. When the slide page is switched, the page number is automatically updated and displayed for the user to view, further improving the convenience of the slide show operation.

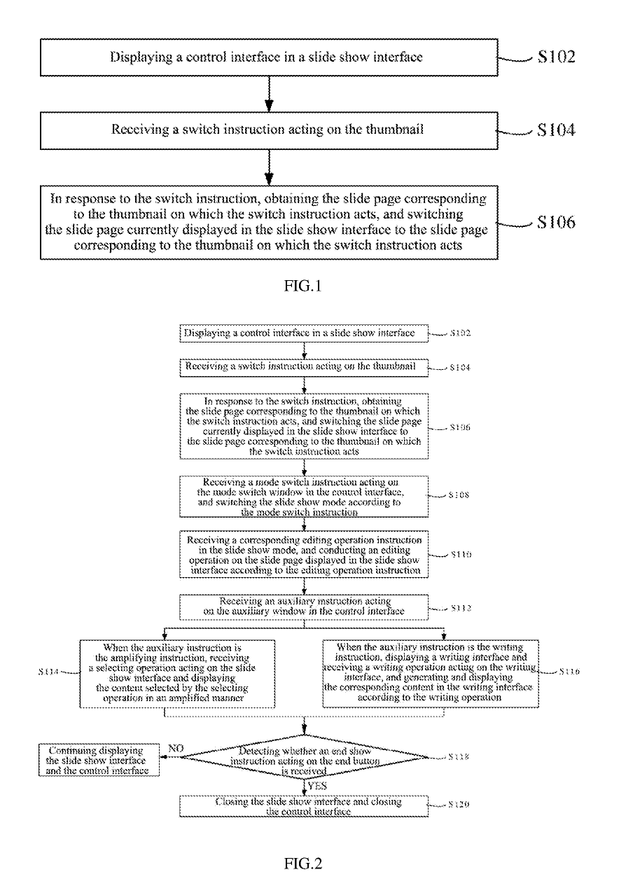

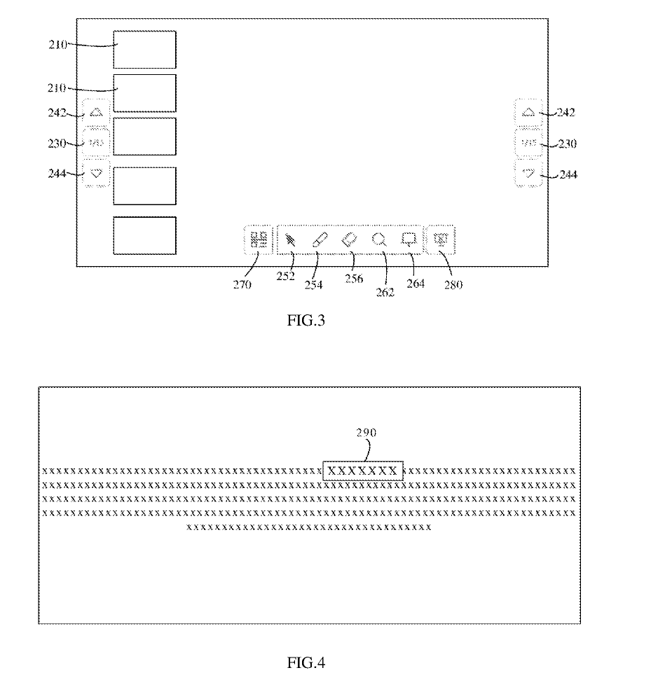

In one of embodiments, a mode switch window is further displayed in the control interface. As shown in FIG. 2, the above method further includes steps S108 and S110.

Step S108: receiving a mode switch instruction acting on the mode switch window in the control interface, and switching to the slide show mode according to the mode switch instruction.

It should be noted that step S108 can either be before step S104 or be after step S104. The manner to input the mode switch instruction is not unique. The mode switch instruction similarly can be generated either by a touch operation or by clicking the mouse. The mode switch window can be provided in the control interface, the mode switch instruction acting on the mode switch window is obtained, and the slide show mode is switched correspondingly. Specifically, the slide show mode includes at least one of a selecting mode, a commenting mode and an erasing mode. Thus, the mode switch window is correspondingly provided with at least one of a selecting button, a commenting button and an erasing button. The user can realize the switch of the slide show mode by clicking the corresponding button.

Step S110: receiving a corresponding editing operation instruction in the slide show mode, and conducting an editing operation on the slide page displayed in the slide show interface according to the editing operation instruction.

The types of the editing operation instructions received in different slide show modes can be different, and the specific manners to conduct the editing operations on the slide page according to the editing operation instructions can also be different accordingly.

Steps S108 and S110 further provide a slide show mode switch function, with which the user can choose different show modes according to the requirements of the slide show and conduct related operations, thus improving the convenience of the slide show operation.

Similarly, using the slide show mode including at least one of the selecting mode, the commenting mode and the erasing mode as an example, step S110 specifically can include the steps 1-3.

Step 1: when the slide show mode is in the selecting mode, receiving a selecting operation acting on the slide show interface, and prominently displaying the content corresponding to the selecting operation in the slide show interface.

The selecting operation can also be a touch operation or a mouse click operation. Using the touch operation as an example, when the selecting mode is entered after the user clicks the selecting button, the touch operation can be conducted in the slide show interface with a finger to select the relevant content for prominently displaying. Prominently displaying refers to displaying the selected content in a manner different from the other content. The selected content can include text, images and tables, etc. Using the text as an example, after the text corresponding to the selecting operation is obtained, the text can be displayed either by highlighting, or in a preset color, or by adding an underline, etc., so as to make the selected text displayed differently from the unselected content.

Step 2: when the slide show mode is in the commenting mode, receiving a commenting operation acting on the slide show interface, and generating and displaying the commenting content in the slide show interface according to the commenting operation. The commenting operation can also be a touch operation or a mouse click operation. Using the touch operation as an example, when the commenting mode is entered after the user clicks the commenting button, a write operation can be conducted in the slide show interface with a finger, which specifically can be adding text and drawing, etc.

Step 3: when the slide show mode is in the erasing mode, receiving an erasing operation acting on the slide show interface, and erasing the content corresponding to the erasing operation in the slide show interface.

The erasing operation can also be a touch operation or a mouse click operation. Using the touch operation as an example, when the erasing mode is entered after the user clicks the erasing button, the erasing operation can be conducted in the slide show interface with a finger, to erase the handwriting written in the commenting mode.

The user can choose from the selecting mode, the commenting mode and the erasing mode according to the requirements of the slide show and conduct related operations. It is understandable that the slide show modes and the corresponding manners of editing and operating are not limited to the above three types. For example, it is also applicable to conduct adding, deleting and replacing operations and the like on the slide page in a revising mode.

In one of embodiments, an auxiliary window is further displayed in the control interface. Still referring to FIG. 2, the above method further includes steps S112-S116.

Step S112: receiving an auxiliary instruction acting on the auxiliary window in the control interface.

It should be noted that step S112 can either be before step S104 or be after step S104. The manner to input the auxiliary instruction is not unique, which similarly can be generated by a touch operation or by clicking the mouse. The auxiliary window can be provided in the control interface to obtain the auxiliary instruction acting on the auxiliary window and confirm the type of the auxiliary instruction. Specifically, the auxiliary instruction includes a magnifying instruction and/or a writing instruction. The auxiliary window is correspondingly set with a magnifying button and/or a writing button. The user can input the auxiliary instruction of a corresponding type by clicking the corresponding button.

S114: when the auxiliary instruction can be the magnifying instruction, receiving a selecting operation acting on the slide show interface and displaying the content selected by the selecting operation in a magnified manner.

The selecting operation can also be a touch operation or a mouse click operation. Using the touch operation as an example, when the magnify function is triggered after the user clicks the magnifying button, the touch operation can be conducted in the slide show interface with a finger to select the relevant content for displaying in the magnified manner. Displaying in the magnified manner refers to conducting magnification processing on the selected content and then displaying the magnified content. The selected content can include text, pictures and tables, etc. Magnifying a local area in the process of presenting the slide can make it more prominent and visible for viewing.

S116: when the auxiliary instruction is the writing instruction, it may cause displaying a writing interface and receiving a writing operation acting on the writing interface, and generating and displaying the corresponding content in the writing interface according to the writing operation. The writing operation can also be a touch operation or a mouse click operation. Using the touch operation as an example, when the user clicks the writing button, a panel-in-panel function is triggered and the writing interface pops up. The user can conduct the writing operation with a finger in the writing interface to generate the corresponding content for displaying. In the process of presenting the slide, a blank area for writing can be rapidly expanded to allow the user to write, thus improving the convenience of the slide show operation.

The writing operation can either be directly performed after the writing interface is displayed, or be performed in the writing interface after the writing interface is displayed and in response to a click of the commenting button. In this embodiment, displaying the writing interface and receiving the writing operation acting on the writing interface in step S116 includes: displaying the writing interface, and receiving the writing operation acting on the writing interface after receiving a click operation acting on the commenting button. With starting conditions being set for the writing function, the writing interface is displayed after the writing instruction is input, and the writing operation is obtained after the click operation acting on the commenting button is received, thus avoiding the mis-operation and improving the reliability of the slide show operation.

Steps S112-S116 further provide an auxiliary function for the slide show. The user can conduct the magnifying or writing operation according to the requirements of the slide show, which improves the convenience of the slide show operation.

Further, in one of embodiments, the method includes the steps corresponding to both the slide show mode switch function and the slide show auxiliary function. The mode switch window and the auxiliary window in the control interface can be provided to be displayed or hidden in the same window. An auxiliary button is further provided in the control interface, and the displaying and hiding of the selecting button, the commenting button, the erasing button, the magnifying button and the writing button are controlled by receiving the instruction acting on the auxiliary button. When there is no need to perform the mode switch function and the auxiliary function for the slide show, the user can hide relevant buttons by clicking the auxiliary button for ease of viewing the slide show.

In one of embodiments, the control interface is further provided with an end button. The method further includes steps S118 and S120.

Step S118: detecting whether an end show instruction acting on the end button is received.

It should be noted that step S118 can either be before step S104 or be after step S104. The manner to input the end show instruction is not unique. The end show instruction similarly can be produced by a touch operation or by clicking the mouse. With the end button provided in the control interface, the user can input the end show instruction by clicking the end button. If the end show instruction acting on the end button is received, step S120 is executed, otherwise the slide show interface and the control interface continue being displayed.

Step S120: closing the slide show interface and closing the control interface

After the end show instruction is received, the slide show interface is closed to exit the slide show state. At the same time, the exit of the slide show state being detected triggers a slide show end event, and the control interface is closed. Similarly, the slide state can be either confirmed by directly monitoring the parameter change of the slide control program, or monitored through a third-party component.

Steps S118 and S120 provide a slide show end control function. The user can input the end show instruction to exit the slide show state, closing the control interface while closing the slide show interface, so that the control interface is displayed only in the slide show state, thus not affecting the other operations of the user and further improving the convenience of the slide show operation.

In one embodiment, the slide show control method includes the steps corresponding to the thumbnail display function, the page-turning function, the page number update function, the slide show mode switch function, the slide show auxiliary function and the slide show end control function. It should be noted that all of these functions can be conducted simultaneously or not simultaneously, and there is no particular sequence among them.

The above slide show control method will be further explained below in combination with specific implementations.

The slide includes PowerPoint, Keynote, and Pages. This specific implementation uses the PowerPoint (PPT) as an example, the monitoring and controlling of the PPT show state can be realized by invoking a COM component (with the dynamic-link library file: Microsoft.Office.Interop.PowerPoint.dll), and auxiliary functions can be added on the basis of the original PPT show, enabling a more convenient operation on the PPT. Through an auxiliary tool, the COM component is initialized and an instance of PPT is created, and the events in the COM component subscribed to include: a start show event, a page switch event, and an end show event.

The start show event is monitored through an interface of the start show event. The auxiliary tool will be informed of the starting of the PPT show through this event. The interface of the start show event specifically is:
Microsoft.Office.Interop.PowerPoint.Application.SlideShowBegin(SlideS howWindow wn).

After detecting the start show event, the auxiliary tool displays the control interface in the PPT show interface in the full-screen manner. As shown in FIG. 3, thumbnails 210 are displayed in the control interface, and the middle blank area is used to display the PPT page. Page number display boxes 230 and page-turning buttons are set on both left and right sides of the control interface. The page-turning buttons include a page-up button 242 and a page-down button 244. The page number display box 230 is located between the page-up button 242 and the page-down button 244. After a slide show event is triggered, screen shots of the PPT pages are taken and stored locally, and are loaded into the auxiliary tool after links with the corresponding PPT pages are established. The interface for taking a screenshot of the PPT is:
Slide ShowWindow.Presentation.Export(stringPath,stringFilterName, intScaleWidth,int ScaleHeight).

The page number of the current PPT page is displayed in the page number display box 230, and the thumbnails 210 are displayed when the page number display box 230 is clicked. The user can click the thumbnails 210 for conducting the page jumping operation, and can also click the page-up button 242 and the page-down button 244 for conducting the page turning operation. The interface for page-up turning is: SlideShowWindow.View.Previous( ) and the interface for page-down turning is: SlideShowWindow.View.Next( ).

The control interface is provided with a selecting button 252, a commenting button 254, an erasing button 256, a magnifying button 262 and a writing button 264, an auxiliary button 270 and an end button 280. The displaying and hiding of the selecting button 252, the commenting button 254, the erasing button 256, the magnifying button 262 and the writing button 264 can be controlled by clicking the auxiliary button 270. The PPT show interface is closed by clicking the end button 280 to exit the presentation mode. The interface for exiting the presentation mode is: SlideShowWindow.View.Exit( ).

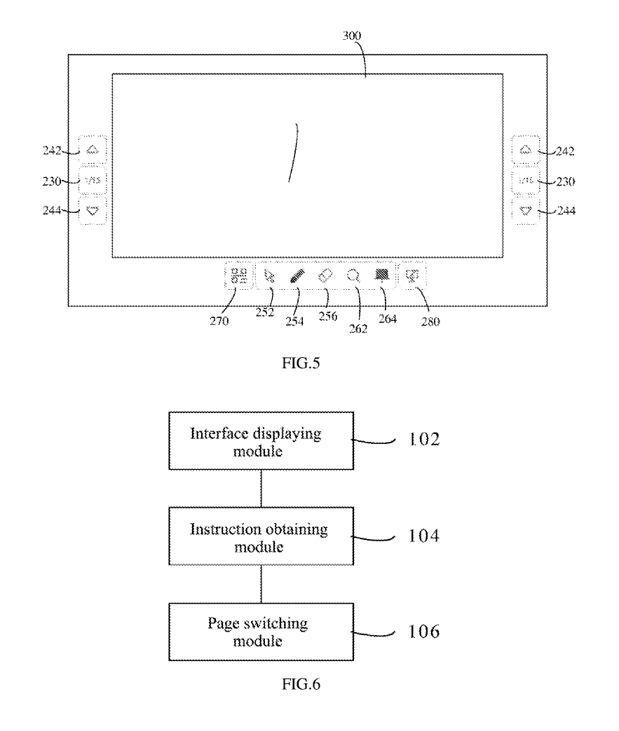

By clicking the selecting button 252, the commenting button 254 and the erasing button 256, the user can switch the current mode of PPT, for example, the selecting mode, the commenting mode and the erasing mode. The interface for switching the current mode of PPT is: SlideShowWindow.View.PointerType. In the commenting mode, the user can conduct the writing operation on PPT, and in the erasing mode, the user can erase the handwriting. By clicking the magnifying button 262 and the writing button 264, the user can use a magnify function and a panel-in-panel function to display the presentation content in the magnified manner or to display a writing interface for writing by the user. As shown in FIG. 4, when the magnify function is used, a magnifying box 290 pops up to display the magnified content. As shown in FIG. 5, a writing interface 300 is displayed after the user clicks the writing button 264, and the writing operation can be conducted after the user clicks the commenting button 254.

The page switch event is monitored by an interface of the page switch event, and the auxiliary tool is informed of the page switch of PPT through this event. The interface of the page switch event is:
Microsoft.Office.Interop.PowerPoint.Application.SlideShowNextSlide(SlideShowWindow wn).

After the page switch of PPT is detected, the auxiliary tool obtains the page number of the current PPT page, and updates the page number in the page number display boxes 230 on the left and right sides. The interface for obtaining the current page number of PPT is: SlideShowWindow.View.CurrentShowPosition.

The end show event is monitored through an interface of the end show event, and the auxiliary tool is informed of the end of the PPT show through this event. The interface of the end show event is:
Microsoft.Office.Interop.PowerPoint.Application.SlideShowEnd(Presentationpres).

After the auxiliary tool receives the end show event, the control interface is closed so as not to affect the other operations of the user, reaching the goal of the control interface being displayed only in the PPT show state.

A slide show control apparatus in an embodiment is illustrated by being applied to an intelligent terminal having a slide show function. As shown in FIG. 6, the apparatus includes an interface displaying module 102, an instruction obtaining module 104, and a page switching module 106.

The interface displaying module 102 is to display a control interface in a slide show interface.

A thumbnail corresponding to a slide page is displayed in the control interface. The slide show interface refers to an interface for showing slides, which can be displayed in the screen of the intelligent terminal in a full-screen manner or displayed in a window. The thumbnail is linked to the corresponding slide page, and serves as a preview and a catalog of an image file. The specific number of thumbnails corresponds to the number of pages of the slides. In this embodiment, the thumbnails are obtained by using screen shots of the slide pages after a slide show event is triggered, and are displayed in the control interface and correspond to the respective slide pages. The thumbnails are generated during the slide show, avoiding procedural wastes. In addition, when the number of thumbnails is more than one, the thumbnails can be combined according to the presentation order of the slide pages and then displayed in the control interface in the form of a thumbnail list.

The control interface can be displayed in the slide show interface, either when the slide is detected as being in the show state, or when the slide is detected as being in the show state and a start instruction is received. Using a touch operation as an example, when the slide is in the show state, if a user's touch operation in the slide show interface is detected, then the control interface is displayed in the slide show interface, so that the user can control the slide show.

Specifically, by monitoring the slide state, when the slide is detected as being in the show state, a slide show event is triggered and the control interface is displayed in the slide show interface. Specifically, a page number display box is displayed in the control interface, and the interface displaying module 102 displaying the control interface in the slide show interface includes: displaying the control interface in the slide show interface, and displaying the thumbnails in the control interface after receiving a click instruction acting on the page number display box in the control interface. The page number display box displaying the page number of the slide can be set in the control interface at first; specifically, the page number display box can be displayed on one or more sides of the control interface. The thumbnails are displayed after the click instruction acting on the page number display box is received. When showing the slides, the user can choose according to actual situation whether to display the thumbnails for assisting the page switch operation or not, thus improving the convenience of the slide show operation.

The instruction obtaining module 104 is to receive a switch instruction acting on the thumbnail.

The switch instruction is used to select a thumbnail so as to switch to the corresponding slide for display. The manner to input the switch instruction is not unique. Specifically, the switch instruction can either be produced by a touch operation, such as clicking the thumbnail with a finger or a stylus to input the switch instruction, or be input by clicking the mouse.

The page switching module 106 is to, in response to the switch instruction, obtain the slide page corresponding to the thumbnail on which the switch instruction acts, and switch from the slide page currently displayed in the slide show interface to the slide page corresponding to the thumbnail on which the switch instruction acts.

In this embodiment, after the switch instruction is received, the thumbnail on which the switch instruction acts are obtained, and the slide page currently displayed in the slide show interface is switched to the slide page corresponding to the thumbnail on which the switch instruction acts. With a thumbnail display function added in the show state, the user can view the slide content via the thumbnail, and a page jump operation can be swiftly completed by clicking the thumbnail corresponding to the page to be jumped to.

With the above slide show control apparatus, the control interface is displayed in the slide show interface. After the user inputs the switch instruction on the thumbnail in the control interface, the slide page currently displayed in the slide show interface can be automatically switched to the slide page corresponding to the thumbnail on which the switch instruction acts. And even when a touch device is used to present the slides, the page switch can be done in the show state, simplifying the user's operation.

In one of embodiments, the control interface is further provided with a page-turning button. The apparatus further includes a page-turning operation module, which is to receive a page-turning instruction acting on the page-turning button in the control interface and to conduct the page-turning operation on the slide page according to the page-turning instruction.

With a page-turning function added on the basis of the thumbnail display function, the user can make choices according to actual demand, for example, clicking the thumbnail when the page jump and switch is needed, and clicking the page-turning button when the page turning is needed, thus improving the convenience of the slide show operation.

Further, the apparatus further includes a page number updating module, which is to, when a slide page switch is detected, obtain the page number of the currently displayed slide page and to display this page number in the page number display box in the control interface.

When the user switches the page by clicking the thumbnail, or turns over the page through the page turning function, the detected slide page change triggers a slide switch event, and the page number of the currently displayed slide page is obtained and displayed in the page number display box to have the page number updated.

A page number update function is provided in this embodiment. When the slide page is switched, the page number is automatically updated and displayed for the user to view, thus improving the convenience of the slide show operation

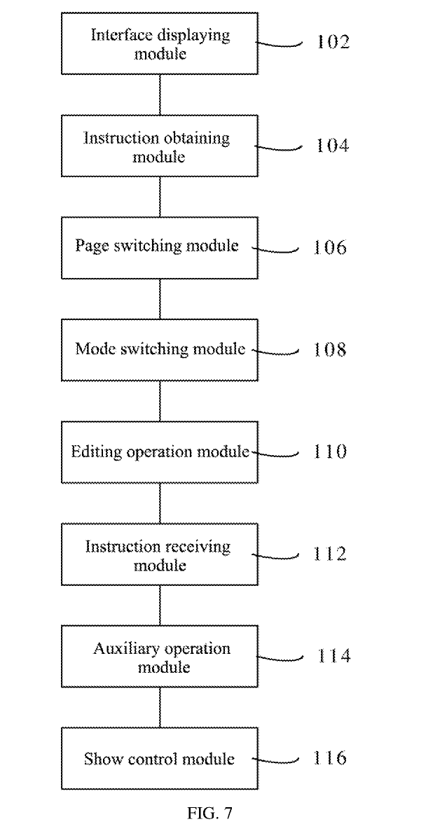

In one of embodiments, a mode switch window is further displayed in the control interface. As shown in FIG. 7, the apparatus further includes a mode switching module 108 and an editing operation module 110.

The mode switching module 108 is to receive a mode switch instruction acting on the mode switch window in the control interface, and switch the slide show mode according to the mode switch instruction.

The mode switch window can be provided in the control interface, the mode switch instruction acting on the mode switch window is obtained, and the slide show mode is switched correspondingly. Specifically, the slide show mode includes at least one of a selecting mode, a commenting mode and an erasing mode. Thus, the mode switch window is correspondingly provided with at least one of a selecting button, a commenting button and an erasing button. The user can realize the switch of the slide show mode by clicking the corresponding button.

The editing operation module 110 is configured to receive a corresponding editing operation instruction in the slide show mode, and conduct an editing operation on the slide page displayed in the slide show interface according to the editing operation instruction.

The types of the editing operation instructions received in different slide show modes can be different, and the specific ways of conducting the editing operations on the slide page according to the editing operation instructions can also be different accordingly.

The mode switching module 108 and the editing operation module 110 further provide a slide show mode switch function, with which the user can choose different show modes according to the requirements of the slide show and perform related operations, thus improving the convenience of the slide show operation.

Similarly, using the slide show mode including at least one of the selecting mode, the commenting mode and the erasing mode as an example, the editing operation module 110 can include at least one of a selecting operation module, a commenting operation module and an erasing operation module.

The selecting operation module is to, when the slide show mode is the selecting mode, receive a selecting operation acting on the slide show interface, and prominently display the content corresponding to the selecting operation in the slide show interface.

The selecting operation can also be a touch operation or a mouse click operation. Using the touch operation as an example, when the selecting mode is entered after the user clicks the selecting button, the touch operation can be performed in the slide show interface with a finger to select the relevant content for prominently displaying. Prominently displaying refers to displaying the selected content in a different manner from the other content. The selected content can include text, images and tables, etc.

The commenting operation module is to, when the slide show mode is the commenting mode, receive a commenting operation acting on the slide show interface, and generate and display the commenting content in the slide show interface according to the commenting operation.

The commenting operation can also be a touch operation or a mouse click operation. Using the touch operation as an example, when the commenting mode is entered after the user clicks the commenting button, a writing operation can be performed in the slide show interface with a finger, which specifically can be adding text and drawing, etc.

The erasing operation module is to, when the slide show mode is the erasing mode, receive an erasing operation acting on the slide show interface, and erase the content corresponding to the erasing operation in the slide show interface.

The erasing operation can also be a touch operation or a mouse click operation. Using the touch operation as an example, when the erasing mode is entered after the user clicks the erasing button, the erasing operation can be conducted in the slide show interface with a finger, to erase the handwriting written in the commenting mode.

The user can choose from the selecting mode, the commenting mode and the erasing mode according to the requirements of the slide show and conduct related operations. It is understandable that the slide show modes and the corresponding manners of editing and operating are not limited to the above three types. For example, it is also applicable to conduct adding, deleting and replacing operations and the like on the slide page in a revising mode.

In one of embodiments, an auxiliary window is further displayed in the control interface. Still referring to FIG. 7, the apparatus further includes an instruction receiving module 112 and an auxiliary operation module 114.

The instruction receiving module 112 is to receive an auxiliary instruction acting on the auxiliary window in the control interface.

The auxiliary window can be provided in the control interface, and the auxiliary instruction acting on the auxiliary window is obtained and the type of the auxiliary instruction is confirmed. Specifically, the auxiliary instruction includes a magnifying instruction and/or a writing instruction. The auxiliary window is correspondingly set with a magnifying button and/or a writing button. The user can input the auxiliary instruction of a corresponding type by clicking the corresponding button.

The auxiliary operation module 114 is to, when the auxiliary instruction is the magnifying instruction, receive a selecting operation acting on the slide show interface and display the content selected by the selecting operation in a magnified manner; when the auxiliary instruction is the writing instruction, display a writing interface and receive a writing operation acting on the writing interface, and generate and display the corresponding content in the writing interface according to the writing operation.

Displaying in the magnified manner refers to conducting magnification processing on the selected content and then displaying the magnified content. The selected content can include text, pictures and tables, etc. Magnifying a local area in the process of presenting the slide can make it more prominent and visible for viewing. When the user clicks the writing button, a panel-in-panel function is triggered and the writing interface pops up. The user can conduct the writing operation with a finger in the writing interface to generate the corresponding content for displaying. In the process of presenting the slide, a blank area for writing can be rapidly expanded to allow the user to write, thus improving the convenience of the slide show operation.

In this embodiment, the auxiliary operation module 114 displaying the writing interface and receiving the writing operation acting on the writing interface, includes: displaying the writing interface, and receiving the writing operation acting on the writing interface after receiving a click operation acting on the commenting button. With starting conditions being set for the writing function, the writing interface is displayed after the writing instruction is input, and the writing operation is obtained after the click operation acting on the commenting button is received, avoiding the mis-operation and improving the reliability of the slide show operation.

The instruction receiving module 112 and the auxiliary operation module 114 further provide a slide show auxiliary function. The user can perform the magnifying or writing operation according to the requirements of the slide show, thus improving the convenience of the slide show operation.

Further, the mode switch window and the auxiliary window in the control interface can be set to be displayed or hidden in the same window. An auxiliary button is further set in the control interface, and the displaying and hiding of the selecting button, the commenting button, the erasing button, the magnifying button and the writing button are controlled by receiving the instruction acting on the auxiliary button. When there is no need to perform the slide show mode switch function and the slide show auxiliary function, the user can hide relevant buttons by clicking the auxiliary button for the ease of viewing the slide show.

In one of embodiments, the control interface is further provided with an end button. The apparatus further includes a show control module 116.

The show control module 116 is to detect whether an end show instruction acting on the end button is received, and if so, close the slide show interface and close the control interface.

With the end button provided in the control interface, the user can input the end show instruction by clicking the end button. If the end show instruction acting on the end button is received, the slide show interface and the control interface are closed, otherwise the slide show interface and the control interface continue being displayed. After the end show instruction is received, the slide show interface is closed to exit the slide show state. At the same time, the exit of the slide show state being detected triggers a slide show end event and the control interface is closed. Similarly, the slide state can be either confirmed by directly monitoring the parameter change of a slide control program, or monitored through a third-party component.

In this embodiment, a slide show end control function is provided. The user can input the end show instruction to exit the slide show state, closing the control interface while closing the slide show interface, so that the control interface is displayed only in the slide show state, thus not affecting the other operations of the user and further improving the convenience of the slide show operation.

The above embodiments only give several specific implementations of the present invention, which are described in detail, but this should not be construed as limiting the scope of the invention. It should be noted that it is possible for those skilled in the art to make a number of changes and improvements without departing from the concept of the present invention, which shall all belong to the protection scope of the present invention. Therefore, the protection scope of the present invention is subject to the appended claims.

1. A slide show control method, comprising:
displaying a control interface in a slide show interface, wherein displaying the control interface comprises displaying a thumbnail corresponding to a slide page in the control interface;
receiving a switch instruction acting on the thumbnail; and
in response to receiving the switch instruction, obtaining the slide page corresponding to the thumbnail on which the switch instruction acts, and switching a slide page currently displayed in the slide show interface to the slide page corresponding to the thumbnail on which the switch instruction acts.

2. The method according to claim 1, wherein further comprising:
displaying a mode switch window is displayed in the control interface; the method further comprises:
receiving a mode switch instruction acting on the mode switch window in the control interface, and switching a slide show mode according to the mode switch instruction; and
receiving a corresponding editing operation instruction in the slide show mode, and performing an editing operation on the slide page displayed in the slide show interface according to the editing operation instruction.

3. The method according to claim 2, wherein the slide show mode comprises at least one of a selecting mode, a commenting mode, or an erasing mode,
wherein the receiving a corresponding editing operation instruction in the slide show mode, and conducting an editing operation on the slide page displayed in the slide show interface according to the editing operation instruction comprises:
when the slide show mode is the selecting mode, receiving a selecting operation acting on the slide show interface, and prominently displaying a content corresponding to the selecting operation in the slide show interface;
when the slide show mode is the commenting mode, receiving a commenting operation acting on the slide show interface, and generating and displaying a commenting content in the slide show interface according to the commenting operation; and
when the slide show mode is the erasing mode, receiving an erasing operation acting on the slide show interface, and erasing a content corresponding to the erasing operation in the slide show interface.

4. The method according to claim 1, further comprising:
displaying an auxiliary window in the control interface;
receiving an auxiliary instruction acting on the auxiliary window in the control interface, the auxiliary instruction comprising at least one of a magnifying instruction or a writing instruction;
when the auxiliary instruction is the magnifying instruction, receiving a selecting operation acting on the slide show interface, and displaying a content selected by the selecting operation in a magnified manner; and
when the auxiliary instruction is the writing instruction, displaying a writing interface and receiving a writing operation acting on the writing interface, and generating and displaying a corresponding content in the writing interface according to the writing operation.

5. The method according to claim 4, wherein the mode switch window and the auxiliary window are arranged to be one of displayed or hidden in a same window.

6. A slide show control apparatus, comprising:
an interface displaying module, to display a control interface in a slide show interface, wherein a thumbnail corresponding to a slide page is displayed in the control interface;
an instruction obtaining module, to receive a switch instruction acting on the thumbnail; and
a page switching module, to, in response to the switch instruction, obtain the slide page corresponding to the thumbnail on which the switch instruction acts, and switch a slide page currently displayed in the slide show interface to the slide page corresponding to the thumbnail on which the switch instruction acts.

7. The apparatus according to claim 6, wherein a mode switch window is displayed in the control interface; the apparatus further comprises:
a mode switching module, to receive a mode switch instruction acting on the mode switch window in the control interface, and switch a slide show mode according to the mode switch instruction;
an editing operation module, to receive a corresponding editing operation instruction in the slide show mode, and conduct an editing operation on the slide page displayed in the slide show interface according to the editing operation instruction.

8. The apparatus according to claim 7, wherein the editing operation module comprises at least one of a selecting operation module, a commenting operation module, or an erasing operation module;
the selecting operation module is to, when the slide show mode is a selecting mode, receive a selecting operation acting on the slide show interface, and prominently display a content corresponding to the selecting operation in the slide show interface;
the commenting operation module is to, when the slide show mode is a commenting mode, receive a commenting operation acting on the slide show interface, and generate and display a commenting content in the slide show interface according to the commenting operation; and
the erasing operation module is to, when the slide show mode is an erasing mode, receive an erasing operation acting on the slide show interface, and erase a content corresponding to the erasing operation in the slide show interface.

9. The apparatus according to claim 6, wherein an auxiliary window is further displayed in the control interface; the apparatus further comprises:
an instruction receiving module, to receive an auxiliary instruction acting on the control interface, the auxiliary instruction comprising at least one of a magnifying instruction or a writing instruction; and
an auxiliary operation module, configured to, when the auxiliary instruction is the magnifying instruction, receive a selecting operation acting on the slide show interface, and display a content selected by the selecting operation in a magnified manner; when the auxiliary instruction is the writing instruction, display a writing interface and receive a writing operation acting on the writing interface, and generate and display a corresponding content in the writing interface according to the writing operation.

10. The apparatus according to claim 6, wherein an end button is provided in the control interface; the apparatus further comprises:
a show control module, to, detect whether an end show instruction acting on the end button is received, and if so, close the slide show interface and close the control interface.
